(19) United States
(12) Patent Application Publication
(10) Pub. No.: US 2024/0208871 A1
(43) Pub. Date: Jun. 27, 2024

(54) DENSE SINTERED MATERIAL OF SILICON CARBIDE WITH VERY LOW ELECTRICAL RESISTIVITY

(71) Applicant: SAINT-GOBAIN CENTRE DE RECHERCHES ET D'ETUDES EUROPEEN, COURBEVOIE (FR)

(72) Inventors: Giovanni MASSASSO, SALON-DE-PROVENCE (FR); Costana BOUSQUET, CAVAILLON (FR)

(21) Appl. No.: 18/557,132

(22) PCT Filed: Apr. 29, 2022
(86) PCT No.: PCT/FR2022/050831

§ 371 Date: Oct. 25, 2023

(30) Foreign Application Priority Data
Apr. 30, 2021 (FR) FR2104577

(51) Int. Cl. C04B 35/575

(52) U.S. Cl. CPC C04B 35/575; C04B 2235/3834; C04B 2235/401; C04B 2235/402; C04B 2235/405; C04B 2235/721; C04B 2235/728; C04B 2235/785; C04B 2235/786; C04B 2235/85

(57) ABSTRACT

A polycrystalline sintered ceramic material of very low electrical resistivity includes by mass more than 95% silicon carbide (SiC), less than 1.5% silicon in another form than SiC, less than 2.5% carbon in another form than SiC, less than 1% oxygen (O), less than 0.5% aluminum (Al), less than 0.5% of the elements Sc, Y, La, Ce, Pr, Nd, Pm, Sm, Eu, Gd, Tb, Dy, Ho, Er, Tm, Yb and Lu, less than 0.5% alkali elements, less than 0.5% alkaline earth, between 0.1 and 1.5% nitrogen (N), the other elements forming the complement to 100%, wherein the grains of the above material have a median equivalent diameter of between 0.5 and 5 micrometers, the mass ratio of SiC alpha (α)/SiC beta (β) is less than 0.1, and the total porosity represents less than 15% by volume of the material.

The invention relates to a dense material based on silicon carbide (SIC) that can in particular be used for its high electrical conductivity properties.

Silicon carbide materials have been known for a long time for their high degrees of hardness, chemical inertia, thermal and mechanical resistance, and thermal conductivity. This makes them candidates of choice for applications such as cutting or machining tools; turbine components or pump elements subjected to high abrasion; pipe valves carrying corrosive products; supports and membranes intended for filtration or pollution or liquid; supports and membranes for filtration or removal of gas or liquid; heat exchangers and solar absorbers, coatings or materials for thermochemical treatment of reactors, in particular for etching, or substrates intended for the electronics industry, temperature sensors or heating resistors; high temperature or pressure sensors or sensors for very aggressive environments; igniters or magnetic susceptors that are more resistant to oxidation than those made of graphite; and even certain special applications such as mirrors or other optical devices.

However, this type of material has a variable or even high electrical resistivity (on the order of 0.1 to several tens of ohms-cm at 20° C.) which is limiting in service. In order to reinforce, for example, the use of this material, in particular as an igniter, it has been proposed by U.S. Pat. Nos. 3,974,106, 5,045,237 or U.S. Pat. No. 5,085,804, different hot-sintered silicon carbide materials with additions of aluminum, boron, or silicon nitride, and/or molybdenum disilicide. However, these materials have a low silicon carbide content or a high porosity, which penalize their performance, moreover, in particular their thermal conductivity or their high temperature properties.

More recently, the publication “Electrical resistivity of silicon carbide ceramics sintered with 1 wt % aluminum nitride and rare earth oxide” in Journal of the European Ceramic Society 32(2012) 4427-4434 by Young-Wook Kim et al. studied the influence of adding rare earth metals associated with AlN on the electrical resistivity of sintered SiC bodies. The starting mixture essentially containing SiC in beta or cubic crystalline form, forming additives including a siloxane and a phenolic resin, and less than 1% by mass of a rare earth powder and an AlN powder. This mixture is dried, shaped by unidirectional pressing and then hardened at 200° C. in order to obtain a workpiece which is pretreated at 1450° C. before being sintered under 20 Mpa at a temperature of 2050° C. under nitrogen. The materials obtained have a relative density of greater than 95% and a resistivity between 1.5·10⁻⁴ and 2.9·10⁻² ohm-m is between 15 and 290 milliomh-cm according to the added rare earth element.

As explained by Y. Taki et al in the publication “Electrical and thermal properties of nitrogen doped SiC sintered body” in the journal Japan Society Powder Metallurgy Vol. 65 No. 8 2018, adding Al in AlN form, however, leads to a liquid phase favorable to densification but harmful to high-temperature mechanical properties.

Solid phase sintering techniques without resorting to a liquid phase such as pressureless sintering from adding boron and carbon have also been known for a long time as is described for example by U.S. Pat. No. 4,004,934. More recently, as shown by the publication “Pressureless sintering of beta silicon carbide nanoparticles” in Journal of the European Ceramic Society 32 (2012) 4393-4400 by A. Malinge et al, the use of starting powders of silicon carbide of submicron size of beta crystallographic form made it possible to achieve a relative density on the order of 90%. However, the sintering temperature necessary for this densification inevitably leads to the formation of an alpha silicon carbide phase as explained by this publication, which increases electrical resistivity.

The object of the present invention is therefore to provide a sintered SiC material having a low electrical resistivity, that is to say less than 100, preferably less than 50 milliohm-cm, and high mechanical and thermal properties, including at high temperature.

It has been demonstrated by the work of the applicant company, described below, an optimum in terms of physical/chemical composition resulting in an extremely low electrical resistivity (less than 50 milliohm-cm at room temperature (20° C.) while maintaining the lowest possible porosity (less than 10% by volume) without the use of additions based on aluminum elements or rare earth metals which are penalizing at high temperatures. This was obtained by an appropriate selection of the starting materials and a particular method making it possible to minimize or even avoid the formation of SiC in alpha form and any formation of liquid phase in the grain boundaries. Indeed, it has been found by the applicant company that these two factors could adversely affect the electrical conductivity.

The invention thus relates, according to a first aspect, to a polycrystalline ceramic material consisting of sintered grains with a median equivalent diameter of between 0.5 and 5 micrometers, said material comprising by mass more than 95% silicon carbide (SiC), preferably more than 97% silicon carbide, and having the following elemental composition in mass:
less than 1.5% silicon in another form than SiC,
less than 2.5% carbon in another form than SiC, and
less than 1%, preferably less than 0.75%, preferably less than 0.5% oxygen (O), and
less than 0.5% aluminum (Al) and
less than 0.5% in total of the elements Sc, Y, La, Ce, Pr, Nd, Pm, Sm, Eu, Gd, Tb, Dy, Ho, Er, Tm, Yb and Lu, and
less than 0.5% alkali elements, and
less than 0.5% alkaline earth, and
preferably less than 0.50% boron (B), more preferably less than 0.2% boron,
between 0.05 and 1% nitrogen (N),
the other elements forming the complement to 100%,
   and wherein:
the mass ratio of the SiC content in alpha crystallographic form (a) on the SiC content in beta crystallographic form (B) of said material is less than 0.1, preferably less than 0.05, and
the total porosity represents less than 15%, preferably less than 12%, more preferably less than 10%, in percentage by volume of said material.

The elemental composition described above in the elements Si, C, O, Al, etc., is understood to mean, of course, in addition to the silicon carbide, that is to say in addition to the more than 95% (preferably more than 97%) by mass of silicon carbide present in said material.

Silicon in another form than SiC may in particular be present in the form of free silica and/or free silicon (metallic silicon).

The carbon in another form than SiC may in particular be present in the form of free carbon.

According to other optional but advantageous additional features of said material:
The material comprises more than 0.1%, preferably more than 0.5% silicon in another form than SiC, in particular in the form of free silica and/or free (metallic) silicon.
The material comprises more than 0.1%, preferably more than 0.5% carbon in another form than SiC, in particular in free carbon form.
The material comprises more than 0.1%, preferably more than 0.5% oxygen (O).
The material does not comprise, other than in the form of unavoidable impurities, silicon in another form than SiC,
The material does not comprise, other than in the form of unavoidable impurities, carbon in another form than SiC.

The material does not comprise, other than in the form of unavoidable impurities, the elements oxygen (O), aluminum (Al), Sc, Y, La, Ce, Pr, Nd, Pm, Sm, Eu, Gd, Tb, Dy, Ho, Er, Tm, Yb and Lu, alkali metals, alkaline earths

The material does not comprise, other than in the form of unavoidable impurities, boron.

The material does not comprise, other than in the form of unavoidable impurities, other elements.
the total elemental content of Sodium (Na)+Potassium (K)+Calcium (Ca) is cumulatively less than 0.5% of the mass of said material.
the elementary mass content of aluminum (Al) represents less than 0.3% of the mass of said material.
the total elemental alkali, alkaline earth, aluminum and rare earth content is cumulatively less than 2%, preferably less than 1%, more preferably less than 0.5% of the mass of said material.
the elemental content of boron (B) is less than 0.2% of the mass of said material, and/or greater than 0.02% of the mass of said material.
the elemental content of Zirconium (Zr) is less than 1.0%, preferably less than 0.8%, preferably less than 0.5% of the mass of said material,
the elemental content of Zirconium (Zr) is greater than 0.02%, preferably greater than 0.05%, preferably greater than 0.1%, preferably greater than 0.2% of the mass of said material.
the elemental content of molybdenum (Mo) is less than 0.2% of the mass of said material, preferably less than 0.1% of the mass of said material.
the elemental content of Titanium (Ti) is less than 1.0%, preferably less than 0.8%, preferably less than 0.5% of the mass of said material,
the elemental content of Titanium (Ti) is greater than 0.02%, preferably greater than 0.05%, preferably greater than 0.1%, preferably greater than 0.2% of the mass of said material.
the elemental content of Hafnium (Hf) is less than 1.0%, preferably less than 0.8%, preferably less than 0.5% of the mass of said material
the elemental content of Hafnium (Hf) is greater than 0.02%, preferably greater than 0.05%, preferably greater than 0.1%, preferably greater than 0.2% of the mass of said material.
the total elementary content of Zr, Hf and Ti is between 0.05% and 1%.
the elemental nitrogen content is greater than 0.1%.
the elemental content of nitrogen is less than 0.8%, preferably less than 0.7%, preferably less than 0.5% of the mass of said material.
the elementary mass content of iron (Fe) represents less than 0.5% of the mass of said material.
silicon in another form than silicon carbide SiC represents less than 1% of the mass of said material.
Carbon in another form than silicon carbide SiC represents less than 2% of the mass of said material.
The mass content of free or residual carbon in said material is less than 1.5%, preferably less than 1.0%.
The mass content of free or residual silica in said material is less than 1.5%, preferably less than 1.0%, preferably less than 0.5%.
The mass content of free or residual silicon in said material is less than 0.5%, preferably less than 0.1%.
Oxygen represents less than 0.4%, preferably less than 0.3%, of the mass of said material.
SiC represents more than 97%, preferably more than 98% of the mass of said material.
SiC in beta crystallographic form (B) represents preferably more than 90% of the mass of the crystalline phases of said material.
the equivalent diameter of the silicon carbide grains in alpha crystallographic form is less than 10 micrometers.
by volume, more than 90%, preferably more than 95% of the grains have an equivalent diameter of between 0.5 and 5 microns, preferably between 0.5 and 3 microns.
by volume of said material apart from its porosity, more than 90%, preferably more than 93%, more preferably more than 95% of the grains are silicon carbide grains in beta crystalline form. The term “silicon carbide grains in beta crystalline form” means grains whose beta SiC mass content is greater than 93%, preferably greater than 95%, preferably greater than 97%.
the grains of said material, the equivalent diameter of which is between 0.5 and 5 microns, are essentially in beta crystallographic form.
silicon carbide grains in alpha crystalline form represent less than 10%, preferably less than 5% by volume of said material except for its porosity. According to one embodiment, said material may comprise at least 0.5% silicon carbide grains in alpha crystalline form, apart from its porosity.
In particular more than 90% by volume, preferably more than 95%, even more preferably all the silicon carbide grains in alpha crystalline form have an equivalent diameter of less than 5 micrometers, preferably less than 2 micrometers, or even less than 1 micrometer, the growth of such grains being inhibited according to the invention so as to minimize the electrical resistivity of said material.
In the material constituting the material according to the invention, the nitrogen is present in the grains by insertion into the crystal lattice of the SiC. The nitrogen is also present at the surface of the constituent grains of the material and the grain boundaries, as the elements Si and C primarily are.
The total porosity of said material is less than 5%, preferably less than 4%, more preferably less than 3%, by volume of said material.
the median pore diameter of said material is less than 2 micrometers.
The material has an electrical resistivity, measured at 20° C. and at atmospheric pressure, of less than 50 milliohm-cm, preferably less than 30 milliohm-cm, preferably less than 20 milliohm-cm.

In the present description, unless otherwise specified, all the percentages are
by mass for the chemical or crystallographic compositions and
by volume for grain or pore sizes.

The invention also relates to a method for manufacturing said material comprising the following steps:
a) preparing a feedstock comprising and preferably consisting essentially of, by mass:
   at least 95% a powder of silicon carbide particles with a median size of between 0.1 and 5 micrometers, the silicon carbide content of which in beta crystalline form is at least 95% by mass, and
   preferably less than 0.2% a sintering additive preferably comprising boron, and
   less than 3% carbon or a carbon precursor, preferably a non-crystallized or amorphous graphite or carbon powder, the median diameter of which is less than 1 micrometer,
   less than 2% silicon or a silicon precursor, preferably a metal or amorphous silicon powder, preferably metallic, the median diameter of which is less than 5 micrometers.
b) shaping the feedstock into the form of a preform, preferably by pouring,
c) solid phase sintering of said preform under a pressure greater than 60 MPa, preferably greater than 75 MPa, or even 80 MPa, and at a temperature greater than 1800° C. and less than 2100° C. in a nitrogen atmosphere, preferably under dinitrogen.

These possible limited additions of carbon or silicon precursor have the purpose of respectively reacting the residual silicon or silica or the residual carbon present in the silicon carbide beta powder in order to form silicon carbide by reaction.

According to other optional and advantageous additional features of said method:
The mass content of nitrogen of the silicon carbide powder in beta crystalline form is greater than 0.1%, preferably less than 1%.
The specific surface area of the silicon carbide powder in beta crystalline form is greater than 5 cm²/g and/or less than 30 cm²/g.
the elementary mass content of aluminum in the silicon carbide powder in beta crystalline form is less than 0.1%.
the sum of the elementary mass contents Na+K+Ca+Mg in the silicon carbide powder in beta crystalline form is less than 0.2%.
the sum of the elementary mass contents Sc+Y+La+Ce+Pr+Nd+Pm+Sm+Eu+Gd+Tb+Dy+Ho+Er+Tm+Yb+Lu in the silicon carbide powder in beta crystalline form is less than 0.5%.
The SiC mass content in the silicon carbide powder essentially in beta crystalline form, that is to say whose beta phase mass content is at least 95%, is greater than 99%.
The mass content of free or residual carbon in the silicon carbide powder essentially in beta crystalline form is less than 3%, preferably less than 2%, preferably less than 1.5%.
The mass content of free or residual silica in the silicon carbide powder essentially in beta crystalline form is less than 2%, preferably less than 1.5%, preferably less than 1%.
The mass content of free or residual silicon in the silicon carbide powder essentially in beta crystalline form is less than 0.5%, preferably less than 0.1%.
The total elemental mass content of contaminants or impurities, represented by the elements or species other than silicon or free silica, the residual carbon, in the silicon carbide powder essentially in beta crystalline form is less than 1%.
Said powder of silicon carbide particles has a mass content of free or residual carbon of less than 3%, of free or residual silica of less than 2%, of free or residual silicon of less than 0.5%, and a total elemental mass content of contaminants or impurities of less than 1.
The silicon carbide powder essentially in beta crystalline form is bimodal and has two peaks, as measured by laser granulometry, even more preferably a first peak, the high point of which is between 0.1 and 0.5 microns and a second peak, the high point of which is between 1 and 6 microns.
The specific surface area of the silicon carbide powder essentially in beta crystalline form is between 5 cm²/g and 30 cm²/g.
the feedstock comprises at least 0.05% of a solid-phase sintering additive, preferably zirconium and/or titanium and/or hafnium, said additive preferably being a metal powder, oxide, nitride, carbide, boride or fluoride of one of these elements. Preferably, the feedstock comprises less than 1% of a sintering additive comprising the element chosen from zirconium and/or titanium and/or hafnium, said additive preferably being a metal powder, oxide, nitride, carbide, boride or fluoride of one of these elements. Said powder being of purity greater than 98% by mass, that is to say that the sum of the other elements is present at a content by weight of less than 2%.
The feedstock does not comprise a solid phase sintering additive. The silicon carbide powder that can be doped with at least one of the elements zirconium and/or titanium and/or hafnium.
the feedstock comprises at least 0.05% silicon or silicon precursor.
The feedstock does not comprise silicon or silicon precursor.
the feedstock does not comprise deliberate addition of aluminum or aluminum precursor, for example in the form of an aluminum nitride powder or an aluminum powder.
the feedstock does not comprise deliberate addition of rare earths or precursor of one of the elements of Sc+Y+La+Ce+Pr+Nd+Pm+Sm+Eu+Gd+Tb+Dy+Ho+Er+Tm+Yb+Lu.
the feedstock comprises at least 0.05% carbon or carbon precursor.
The feedstock does not comprise carbon or carbon precursor.
the median diameter of the sintering powder is less than 2 micrometers, preferably less than 1 micrometer. Preferably, it is a powder of boron carbide.
according to a possible mode, the sintering additive comprises the element zirconium. According to one possible mode, the sintering additive is a powder of carbide, fluoride or zirconium boride.
the feedstock comprises at least 0.5%, preferably at least 1%, of a carbon precursor.
the feedstock comprises less than 0.5% or even no silicon precursor.
The feedstock may optionally comprise less than 1% organic additives provided that they essentially contain the elements between C, O, H, N, Si. For example, acrylic resins, PEG, siloxane, vinyl, epoxy, phenolic, polyurethane compounds or resins, alkyd derivatives or glycerophthalic compounds may be suitable.

Any shaping technique known to the person skilled in the art can be applied as a function of the dimensions of the part to be made as soon as all the precautions are taken to avoid contamination of the preform. Thus, the casting in a plaster mold can be adapted by using graphite media between the mold and the preform or oils avoiding excessive contact and abrasion of the mold by mixing and finally contamination of the preform. These controlled precautions for use by a person skilled in the art are also applicable to other steps of the method. Thus, during sintering, the mold or the matrix used containing the preform will preferably be made of graphite.

Hot pressing, hot isostatic pressing, or SPS (Spark Plasma Sintering) techniques are particularly suitable. Preferably, pressure-assisted sintering is carried out by SPS, a sintering process wherein induction heating is carried out by direct current flow into a graphite matrix wherein the preform is placed. The average temperature rise rate is preferably greater than 10 and less than 100° C./minute. The plateau time at the maximum temperature is preferably greater than 10 minutes. This time may be longer depending on the format of the preform and the load of the furnace. The nitrogen used for the sintering atmosphere in step c) is of purity greater than 99.99%, or even greater than 99.999% by volume.

The invention also relates to a device comprising the material according to the invention, said device being chosen from: a turbine, a pump, a valve or a fluid line system, a heat exchanger; a solar absorber or a device for recovering heat or reflecting light, a furnace refractory coating, a cooking surface, a crucible for metal or metalloid melting, an abrasion protection part, a cutting tool, a brake pad or disc, a coating or support for thermochemical treatment, for example, etching, or a substrate for active layer deposition for the optics and/or electronics industry; a heating element or resistor; a temperature or pressure sensor; an igniter; a magnetic susceptor. Preferably, the device is selected from: a turbine, a pump, a valve or a fluid line system, an abrasion protection part, a cutting tool, a brake pad or disc, a heating element or resistor; a temperature or pressure sensor; an igniter; a magnetic susceptor, a substrate for active layer deposition for the optics and/or electronics industry.

### Definitions

The following indications and definitions are given in connection with the preceding description of the present invention:

Polycrystalline material is understood to mean a material having several crystalline orientations or different crystalline orientation crystals.
In the ceramic material, the sintered grains together represent the essential part of the mass of said material, the intergranular phase optionally consisting of a ceramic and/or metal phase or residual carbon advantageously representing less than 5% of the mass of said material. Unlike so-called liquid-phase sintering, the process of firing the material according to the invention is essentially carried out in solid phase, that is to say that it is a sintering wherein the additives added allowing the sintering or the level of the impurities optionally present do not make it possible to form a liquid phase in an amount such that it is sufficient to allow the rearrangement of the grains and thus bring them into contact with one another. A material obtained by solid phase sintering is commonly called “solid phase sintered”.

Sintering additive, often just called an “additive” is understood to mean within the present description a compound that is customary known for enabling and/or accelerating the kinetics of the sintering reaction.
Impurities are understood to mean the inevitable constituents, unintentionally and necessarily introduced with the raw materials or resulting from the reactions between the constituents. The impurities are not necessary constituents but only the tolerated constituents.
The elemental chemical contents of the sintered material or of the powders used in the mixture of the method for manufacturing said material are measured according to techniques well known in the art. In particular, the levels of elements such as, for example, Al, B, Ti, Zr, Fe, Mo, rare earth metals, alkali metals and alkaline earth metals can be measured by X-ray fluorescence, preferably by ICP (“Induction Coupled Plasma”), depending on the levels present in particular by ICP if the levels are less than 0.5%, or even less than 0.2%, in particular according to the ISO 21068-3:2008 standard for a calcinated product at 750° C. in air until the weight is taken up.

Free silicon content, free silica, free carbon and SiC by mass are measured according to standard ISO 21068-2:2008. These oxygen and nitrogen are determined by LECO according to ISO 21068-3:2008.

The polytype composition of SiC and the presence of other phases of the sintered material or of the powders used in the mixture of the method for manufacturing said material are normally obtained by X-ray diffraction and Rietveld analysis. In particular, the respective percentages of alpha and beta SiC phase can be determined using the D8 Endeavor equipment made by BRUKER using the following configuration:
Acquisition: d5f80: from 5° to 80° in 2θ, 0.01° step, 0.34 s/step, duration 46 min
Front optic: Primary slope 0.3°; Soller slit 2.5°
Sample-holder: Rotation 5 rpm/min automatic cutter
Rear optic: Soller slit: 2.5°; nickel filter 0.0125 mm; PSD: 4°. 1D detector (Current values).

The diffractograms can be analyzed qualitatively with the EVA software and the ICDD2016 database, and then quantitatively with the HighScore Plus software according to a Rietveld refinement.

The percentages by volume of grains of the sintered material in alpha or beta form and their diameter can be determined by analysis of images resulting from observations by electron backscatter diffraction EBSD. The installation may for example be composed of a scanning electron microscope (SEM) equipped with an EBSD detector and spectrometry with energy-dispersive X-ray spectroscopy (EDX). EBSD and EDX detectors are controlled by the software ESPRIT (version 2.1). Images of high crystallographic contrast and/or high density contrast can be collected using available software.

The equivalent diameter of a grain corresponds to the diameter of the disc of the same surface area as that of said grain observed along a cutting plane of the material. Using different sections of material according to at least two perpendicular planes it is possible to have a very good representation of the volume distribution of the different equivalent diameters of the grains and to deduce therefrom the median equivalent diameter (or D₅₀ percentile) of said grains by volume. In the present application, the volume percentage of the sintered grains constituting the material is expressed relative to the volume of material except for its porosity.

This median diameter (or D₅₀ percentile) grains corresponds to the diameter dividing the grains into first and second equal populations, these first and second populations comprising only grains having an equivalent diameter greater than, or less than, respectively, the median diameter.

The same method as described above is also possible to calculate the volume of the intergranular phases optionally present.

The total porosity (or total volume of pores) of the material according to the invention corresponds to the total sum of the volume of closed and open pores divided by the volume of material. It is calculated according to the ratio expressed as a percentage of the bulk density measured according to ISO 18754 to the absolute density measured according to ISO 5018.

The median diameter of the particles (or the median “size”) of the particles constituting a powder can be obtained by a characterization of particle size distribution, in particular by means of a laser particle size analyzer. The characterization of particle size distribution is conventionally carried out with a laser particle size analyzer in accordance with the ISO 13320-1 standard. The laser particle size analyzer can be, for example, a Partica LA-950 from HORIBA.

For the purposes of the present description and unless otherwise mentioned, the median diameter of the particles respectively denotes the diameter of the particles below which 50% by mass of the population is found. “Median diameter” or “median size” of a set of particles is called a powder, the D₅₀ percentile, that is, the size dividing the particles into first and second populations equal in volume, these first and second populations comprising only particles having a size greater than, or less than, respectively, the median size.

The specific surface area is measured by the B.E.T (Brunauer Emmet Teller) method, described for example in the Journal of American Chemical Society 60 (1938), pages 309 to 316.

A powder of particles of silicon carbide in beta crystalline form is understood to mean a powder for which the 3C or cubic crystallographic form represents more than 95% by mass of silicon carbide. The alpha crystallographic forms of the SiC are mainly hexagonal or rhombohedral phases; 3H; 4H; 6H and 15R.

Unless otherwise specified, all percentages in this description are mass percentages.

### FIGURES

FIG. 1 is an image taken with a scanning microscope of a polished section of the sintered material of example 3 according to the invention.

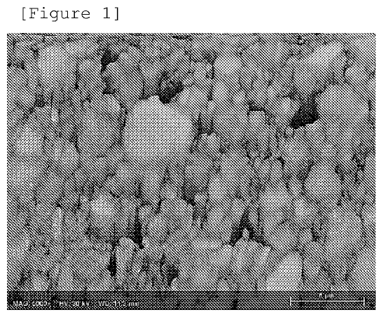

### EXEMPLARY EMBODIMENTS

A non-limiting example is given below, making it possible to produce a material according to the invention, which of course is also not limiting on methods that make it possible to obtain such a material and the method according to the present invention.

Comparative examples are also given below, demonstrating the advantages of the present invention.

In all the following examples, ceramic bodies in the form of cylinders with a diameter of 30 mm and a thickness of 10 mm were initially produced by casting a slip into a plaster mold according to different formulations reported in table 1 below from the following raw materials:
1) a powder of silicon carbide SiC particles in beta crystallographic form, which has a bimodal distribution with a first peak, the highest point of which is located at 0.3 micrometers and a second peak of height substantially twice as high as the first and whose highest point is situated at 3 micrometers, according to a non-cumulative size distribution measured by a laser particle size analyzer, by number. The median diameter of the bimodal powder is 1.5 μm. This SiC powder has the following elementary mass levels:
   Sc+Y+La+Ce+Pr+Nd+Pm+Sm+Eu+Gd+Tb+Dy+Ho+Er+Tm+Yb+Lu<0.5%
   Nitrogen (N)<0.2%; Na+K+Ca+Mg<0.2%; aluminum (Al)<0.1%
   Iron (Fe)<0.05%; Titanium (Ti)<0.05%;
   Molybdenum (Mo)<0.05%;
   Zr<0.1; Hf<0.1
      Its carbon, silica and free silicon contents are respectively less than 2.0%, 1.0%, and 0.1%. Its mass content of beta-SiC phase is greater than 95%.
2) a powder of carbon black provided by Timcal at grade C65 with a BET specific surface area of 62 m²/g.
3) a boron carbide powder provided by H.C. Starck at grade HD-15 with a median diameter of 0.8 μm.
4) a zirconia powder provided by Saint-Gobain Zirpro at grade CY3Z-RA grade with a median diameter of 0.3 μm.
5) a titanium oxide powder supplied by Sigma-Aldrich at grade with a median diameter of 0.1 μm.
6) an aluminum nitride powder provided by Nanografi at grade with a median diameter of 0.06 μm.

Pellets thus produced are dried at 50° C. in air. The pellets of Examples 1 and 2 (comparative) are sintered in an Argon oven at a temperature of 2150° C. for 2 h without pressure or load. The pellets of example 3 (according to the invention) and example 5 (comparative) are loaded into equipment for SPS sintering at 2000° C. under a load of 85 Mpa (megapascals) in a dinitrogen atmosphere. Unlike example 3, the sintering of the pellets of example 4 (comparative) is carried out under vacuum. Example 6 according to the invention is carried out under the same conditions as example 5, but the boron carbide powder is replaced with a zirconia powder, just like in example 8 (also according to the invention) Unlike example 6, in example 7 (according to the invention), the addition is carried out in the form of a titanium oxide powder. In examples 9 and 10 (comparative) unlike example 7, the addition consists of an aluminum nitride powder. The sintering of examples 9 and 10 is respectively the same as that of example 7 (pressure-assisted sintering, in N₂) and that of example 4 (pressure-assisted sintering, under vacuum).

The total porosity of the material obtained is calculated by making the difference between 100 and the ratio expressed as a percentage of the bulk density measured according to ISO 18754 over the absolute density measured according to ISO 5018. Free silica content (SiO₂) is measured by HF attack. The contents of free carbon, of oxygen and nitrogen are measured by LECO. The free silicon content is measured by control with aqua regia, followed by titration. The other elemental levels are measured by X-ray fluorescence and ICP. The percentage of SiC in beta form and the ratio of crystallographic form β/α SiC are determined by X-ray diffraction analysis according to the method described above.

The electrical resistivity is measured at room temperature (20° C.) according to the Van der Pauw method at 4 points on a sample with a diameter of 20-30 mm and a thickness of 2.5 mm.

The percentages by volume of grains of the sintered material in alpha or beta form and their diameter were determined by analysis of images resulting from EBSD observations. The installation is composed of a scanning electron microscope (SEM) equipped with a Bruker e-FlashHR+ EBSD detector equipped with FSE/BSE Argus imaging system and a Bruker XFlash® 4010 EDX detector having an active surface area of 10 mm². The EBSD detector is mounted on one of the rear ports of the FEI Nova NanoSEM 230 scanning electron microscope with a field-emission gun at an angle of inclination equal to 10.6° relative to the horizontal in order to increase both the EBSD signal and the EDX signal. Under these conditions, the optimal working distance WD (that is, distance between the pole piece of the SEM and the analyzed zone of the sample) is about 13 mm. The EBSD and EDS detectors are controlled by the software ESPRIT (version 2.1). FSE images (with high crystallographic contrast) and/or BSE images (with a high density contrast) were collected using the Argus system by positioning the EBSD camera at a distance DD (sample detector distance) of 23 mm in order to be less sensitive to the topography of the sample. The EBSD measurements were carried out in point scanning and/or mapping mode. For this, the EBSD camera was positioned a distance DD of 17 mm in order to increase the collected signal.

The equivalent diameter of a grain corresponds to the diameter of the disc of the same surface area as that of said grain observed along a cutting plane of the material. By observing different sections of material along at least two perpendicular planes, it was possible to determine the distribution of the different equivalent diameters of the grains in the volume of the material and deduce therefrom the median equivalent diameter of said grains by volume.

The characteristics and properties obtained according to examples 1 to 6 are given in table 1 below.

TABLE 1

| | | | | | | | | | |
|---|---|---|---|---|---|---|---|---|---|
| Ex. 1 | Ex. 2 | Ex. 3 | Ex. 4 | Ex. 5 | Ex. 6 | Ex. 7 | Ex. 8 | Ex. 9 | Ex. 10 |
| (comp.) | (comp.) | (inv.) | (comp.) | (comp.) | (inv.) | (inv.) | (inv.) | (comp.) | (comp.) |

Mixture formulation (in % by mass)

| Silicon carbide | 97.0 | 97.9 | 97.9 | 97.9 | 97.6 | 97.5 | 97.5 | 97.0 | 98.1 | 98.1 |
|---|---|---|---|---|---|---|---|---|---|---|
| beta powder | | | | | | | | | | |
| Carbon black powder | 2.0 | 2.0 | 2.0 | 2.0 | 2.0 | 2.0 | 2.0 | 2.0 | 1.4 | 1.4 |
| Boron carbide powder | 1.0 | 0.1 | 0.1 | 0.1 | 0.4 | 0 | 0 | 0 | 0 | 0 |
| Zirconia powder | 0 | 0 | 0 | 0 | 0 | 0.5 | 0 | 1.0 | 0 | 0 |
| Titanium oxide powder | 0 | 0 | 0 | 0 | 0 | 0 | 0.5 | 0 | 0 | 0 |
| Aluminum nitride | 0 | 0 | 0 | 0 | 0 | 0 | 0 | 0 | 0.5 | 0.5 |
| powder | | | | | | | | | | |
| total mineral filler | 100 | 100 | 100 | 100 | 100 | 100 | 100 | 100 | 100 | 100 |
| % water/solvent | +30% | | | | | | | | | |
| additions % relative | +0.4% | | | | | | | | | |
| to the mass of | | | | | | | | | | |
| mineral filler: | | | | | | | | | | |
| binder + dispersant | | | | | | | | | | |
| Sintering/Atmosphere | Ar 2 L/min | Ar 2 L/min | N₂ - | In | N₂ - | N₂ - | N₂ - | N₂ - | N₂ - | In |
| Flow (L/min/m³ | 2150° C. | 2150° C. | 2000° C. | vacuum - | 2000° C. | 2000° C. | 2000° C. | 2000° C. | 2000° C. | vacuum - |
| furnace vol.) | without load | without load | 900 mbar | 2000° C. | 900 mbar | 900 mbar | 900 mbar | 900 mbar | 900 mbar | 2000° C. |
| Temperature | | | 85 MPa | 0.8 mbar | 85 MPa | 85 MPa | 85 MPa | 85 MPa | 85 MPa | 0.8 mbar |
| Internal Pressure | | | | 85 MPa | | | | | | 85 MPa |
| With/without load | | | | | | | | | | |
| (Mpa) or vacuum | | | | | | | | | | |

Chemical characteristics (in percentage by weight of the ceramic material)

| | | | | | | | | | | |
|---|---|---|---|---|---|---|---|---|---|---|
| SiC (excluding | <99 | >99 | >99 | >99 | >99 | >99 | >99 | >98 | >99 | >99 |
| the free C) | | | | | | | | | | |
| N | 0.06 | 0.06 | 0.11 | 0.06 | 0.10 | 0.40 | 0.45 | N.M | 0.23 | 0.22 |
| B | 0.78 | 0.08 | 0.08 | 0.08 | 0.31 | <0.01 | <0.01 | <0.05 | <0.05 | <0.05 |
| + | <0.25 | <0.25 | <0.25 | <0.25 | <0.25 | 0.70 | <0.25 | N.M | 0.15 | 0.10 |
| Na | <0.04 | <0.04 | <0.04 | <0.04 | <0.04 | <0.04 | <0.04 | <0.04 | <0.04 | <0.04 |
| K | <0.05 | <0.05 | <0.05 | <0.05 | <0.05 | <0.05 | <0.05 | <0.05 | <0.05 | <0.05 |
| Ca | <0.04 | <0.04 | <0.04 | <0.04 | <0.04 | <0.04 | <0.04 | <0.04 | <0.04 | <0.04 |
| Mg | <0.04 | <0.04 | <0.04 | <0.04 | <0.04 | <0.04 | <0.04 | <0.04 | <0.04 | <0.04 |
| Zr | <0.02 | <0.02 | <0.02 | <0.02 | <0.02 | 0.45 | <0.02 | 0.78 | <0.02 | <0.02 |
| Hf | <0.02 | <0.02 | <0.02 | <0.02 | <0.02 | N.M | <0.05 | <0.01 | <0.01 | <0.01 |
| Al + Mo + Sc, Y, | 0.11 | 0.11 | 0.11 | 0.11 | 0.11 | 0.11 | 0.11 | 0.12 | 0.4 | 0.4 |
| La, Ce, Pr, Nd, Pm, | | | | | | | | | | |
| Sm, Eu, Gd, Tb, Dy, | | | | | | | | | | |
| Ho, Er, Tm, Yb and Lu | | | | | | | | | | |
| Fe | <0.03 | <0.03 | <0.03 | <0.03 | <0.03 | <0.03 | <0.03 | <0.03 | <0.03 | <0.03 |
| Ti | <0.05 | <0.05 | <0.05 | <0.05 | <0.05 | <0.05 | 0.45 | <0.05 | <0.05 | <0.05 |
| Free (metallic) | <0.01 | <0.01 | <0.01 | <0.01 | <0.01 | <0.01 | <0.01 | <0.01 | <0.01 | <0.01 |
| silicon | | | | | | | | | | |
| Free silica (SiO2) | 0.22 | <0.3 | <0.4 | 0.22 | <0.4 | NM | NM | NM | <0.4 | <0.4 |
| Free carbon (C) | 1.7 | 1.7 | 1.7 | 1.7 | 1.7 | 1.7 | 1.7 | 1.7 | 1.1 | 1.2 |

Crystallographic characteristics (as a % by mass of the crystallized phases of the ceramic material)

| | | | | | | | | | | |
|---|---|---|---|---|---|---|---|---|---|---|
| βSiC (%) | 60 | 80 | 95 | 90 | 47 | 95 | >90 | 95 | 89 | 83 |
| Mass Ratio | 0.7 | 0.2 | <0.1 | >0.1 | 1.1 | <0.1 | <0.1 | <0.1 | 0.11 | <0.1 |
| αSiC/βSiC | | | | | | | | | | |

Structural features relative to the volume of material apart from its porosity

| | | | | | | | | | | |
|---|---|---|---|---|---|---|---|---|---|---|
| Equivalent median | 5.2 | 3.6 | 2.1 | 2.8 | 3.5 | 2.0 | 2.2 | 2.1 | 2.2 | 2.1 |
| diameter of | | | | | | | | | | |
| sintered grains in | | | | | | | | | | |
| microns | | | | | | | | | | |
| % volume of | <90 | <90 | >95 | #90 | >95 | NM | NM | NM | NM | NM |
| grains with a | | | | | | | | | | |
| diameter of | | | | | | | | | | |
| between 0.5 and | | | | | | | | | | |
| 5 micrometers | | | | | | | | | | |
| Equivalent median | 2.0 | 2.0 | 2.0 | 2.0 | 2.0 | NM | NM | NM | NM | NM |
| diameter of the | | | | | | | | | | |
| sintered grains | | | | | | | | | | |
| of βSiC in | | | | | | | | | | |
| micrometers | | | | | | | | | | |
| Equivalent median | >5 | >5 | <5 | >5 | >5 | NM | NM | NM | NM | NM |
| diameter of the | | | | | | | | | | |
| sintered grains | | | | | | | | | | |
| of αSiC in | | | | | | | | | | |
| micrometers | | | | | | | | | | |
| Total porosity (%) | 46.9 | 24.4 | 9.0 | 3.4 | 0.9 | 5.9 | 7.2 | 5.9 | 6.6 | 3.7 |
| Resistivity | 13438 | 9592 | 42 | 342 | 390 | 7 | 20 | 19 | 441 | 2627 |
| (milliohm-cm) | | | | | | | | | | |
| at 20° C. | | | | | | | | | | |

NM = Not measured

The comparison of examples 3 and 6 to 8 according to the invention with the other comparative examples shows that it is possible to obtain, according to the precise and unique conditions of the invention, a material of crystallized silicon carbide that is not very porous and has very little or no electrical resistivity, that is, starting from a pure mixture of SiC in the beta form, a very small amount or even no sintering additive and/or carbon and a pressure-assisted sintering in the presence of a nitrogenous atmosphere. Examples 9 and 10 show that adding aluminum leads to a much higher resistivity regardless of the type of sintering.

1. A polycrystalline ceramic material consisting of sintered grains with a median equivalent diameter of between 0.5 and 5 microns, said material comprising by mass more than 95% silicon carbide (SiC) and having the following elemental composition, by weight:
less than 1.5% silicon in another form than SiC,
less than 2.5% carbon in another form than SiC,
less than 1.0% oxygen (O),
less than 0.5% aluminum (Al)
less than 0.5% in total of the elements Sc, Y, La, Ce, Pr, Nd, Pm, Sm, Eu, Gd, Tb, Dy, Ho, Er, Tm, Yb and Lu,
less than 0.5% alkali elements,
less than 0.5% alkaline earth,
between 0.05 and 1% nitrogen (N),
the other elements forming the complement to 100%,
wherein:
a mass ratio of the SiC content in alpha crystallographic form (a) on the SiC content in beta crystallographic form (B) of said material is less than 0.1,
a total porosity represents less than 15%, in percentage by volume of said material.

2. The polycrystalline ceramic material according to claim 1, having the following elemental composition, by weight:
less than 0.5% oxygen (O) and/or
less than 0.2% boron (B).

3. The polycrystalline ceramic material according to claim 2, wherein a total elemental content of Sodium (Na)+Potassium (K)+Calcium (Ca) is cumulatively less than 0.5% of the mass of said material.

4. The polycrystalline ceramic material according to claim 1, wherein an elemental nitrogen content is less than 0.5% of the mass of said material.

5. The polycrystalline ceramic material according to claim 1, wherein an elemental content of iron (Fe) represents less than 0.5% of the mass of said material.

6. The polycrystalline ceramic material according to claim 1, wherein an elemental content of an element selected from the group consisting of zirconium, titanium, hafnium is greater than 0.02% and less than 1%.

7. The polycrystalline ceramic material according to claim 1, wherein a cumulative elemental content of Zr, Hf and Ti is between 0.05% and 1%.

8. The polycrystalline ceramic material according to claim 1, wherein the SiC represents more than 97% of the mass of said material.

9. The polycrystalline ceramic material according to claim 1, wherein by volume of said material apart from its porosity, more than 90% of the grains have an equivalent diameter of between 0.5 and 5 microns.

10. The polycrystalline ceramic material according to claim 1, wherein by volume of said material apart from its porosity, more than 90% of the grains of said material are silicon carbide grains in beta crystalline form.

11. The polycrystalline ceramic material according to claim 1, wherein an equivalent diameter of the grains of silicon carbide in alpha crystallographic form is less than 10 microns.

12. The polycrystalline ceramic material according to claim 1, having an electrical resistivity, measured at 20° C. and at atmospheric pressure, of less than 50 milliohm-cm.

13. The method of manufacturing a polycrystalline sintered ceramic material according to claim 1, comprising:
a. preparing a feedstock comprising by mass:
at least 95% a powder of silicon carbide particles with a median size of between 0.1 and 5 micrometers, a silicon carbide content of which in beta crystalline form is at least 95% by mass, and
less than 3% carbon or a carbon precursor, a median diameter of which is less than 1 micrometer,
less than 2% silicon or a silicon precursor, a median diameter of which is less than 5 micrometers.
b. shaping the feedstock into the form of a preform,
c. solid phase sintering of said preform under a pressure greater than 60 MPa and at a temperature greater than 1800° C. and less than 2100° C. in a nitrogen atmosphere.

14. The manufacturing method according to claim 13, wherein said powder of silicon carbide particles has a mass content of free or residual carbon of less than 3%, of free or residual silica less than 2%, of free or residual silicon of less than 0.5%, and a total elemental mass content of contaminants or impurities of less than 1%.

15. The manufacturing method according to claim 14, wherein the feedstock comprises less than 0.2% of a solid-phase sintering additive.

16. The manufacturing method according to claim 13, wherein the feedstock comprises at least 0.05% of a solid-phase sintering additive.

17. The manufacturing method according to claim 13, wherein the feedstock does not comprise any silicon or silicon precursor, and/or does not comprise aluminum or aluminum precursor

18. A device comprising the material according to claim 1, said device being chosen from: a turbine, a pump, a valve or a fluid line system, a heat exchanger; a solar absorber or a device for recovering heat or reflecting light, a furnace refractory coating, a cooking surface, a crucible for metal or metalloid melting, an abrasion protection part, a cutting tool, a brake pad or disc, a coating or support for thermochemical treatment, or a substrate for active layer deposition for the optics and/or electronics industry; a heating element or resistor; a temperature or pressure sensor; an igniter; a magnetic susceptor.

19. The polycrystalline ceramic material according to claim 8, wherein the SiC represents more than 98% of the mass of said material.

20. The manufacturing method according to claim 13, wherein the feedstock comprises by mass less than 0.2% a solid phase sintering additive, said additive optionally comprising boron.
